(19) United States
(12) Patent Application Publication
(10) Pub. No.: US 2003/0167825 A1
(43) Pub. Date: Sep. 11, 2003

(54) Water Breaker

(76) Inventor: Danny Joe Buttrum, Hot Springs, AR (US)

Correspondence Address: Danny Buttrum, 206 Peachwood Street, Hot Springs, AR, 71913, US

(21) Appl. No.: 10/055,859

(22) Filed: Mar. 8, 2002

(51) Int. Cl. G01M 3/04

(52) U.S. Cl. 73/40

(57) ABSTRACT

The 120 volt AC is changed to 24 volt AC through a 24 volt center tap 1 amp transformer to provide two 12 volt sources which goes to two bridge rectifiers to supply two sources of 12 volt DC. The first rectifier which supplys 12 volts to a 12 volt DC 2 amp 2 pole 2 throw relay through the contacts of a 24 volt AC 5 a 3 pole 2 throw relay. The 24 volt AC relay is turned on by the reset switch which is normaly open. This switch supplys 24 volts to the 24 volt AC relay when the 24 volt relay energizes, one set of contacts energize the 12 volt DC relay, the second set of contacts turns on whatever is plugged into the 120 volt AC outlet. The third set of contacts latch the 24 volt relay to stay on. When the 12 volt DC relay is energized it supplys 12 volt DC to the electrolytic capacitor 2200 uf@ vDC which puts a 30 ms pulse on the water valves causing the water valves to open.

When water touches the sensor, a current flows through a 22k ohm 0.25 watt resistor to the base of transistor mps4124 turning on the transistor mps4124 this in turn,turns on transistor c638 ph00 which supplys voltage to the gate of the track bt a06 400t causing it to open the circuit to the 24 volt AC relay. This opens the contacts to the 12 volt DC relay causing the 12 volts to be reversed to the capactor causing a 30 ms negative pulse to be applied to the water valve. This causes the water valve to shut the water off. At the same time another set of contacts in the 24 volt AC relay opens a circuit to the device that is plugged into the AC outlet.The bridge rectifier ecg 166 supplys 12 vDC to the pulse circuit resistor 470 ohm 1 watt and transistor c2834a npn regulates the 12 volt DC and the electrolytic capacitor supplys the current needed for the positive and negative pulse. The positive voltage is supplyed by a resistor 100k ohm 0.25 watt and the negative voltage is supplied by a general purpose rectifier ecg125. The lamp 28 volts bayonet base is connected to the energizing coil of the 24 volt AC relay, this lamp is on when the 24 volt AC relay is on supplying power to the AC outlet.

The Water Breaker is made up of parts listed below: power supply cord six by six inch box, three inches deep, a transformer, silinoid switch, transister, reset button, power outlet, two magnetic valves, and a sensor.

The box mounts to the wall behind the washing machine and plugs into wall power outlet.

The washing machine is pluged into the control box power outlet, the sensor is placed on floor behind the machine, and pluged into control box.

The magnetic valves are placed on the hot and cold hydron. then, the hoses are connected to the valves and to the washing machine. what makes the magnetic valves unique is that they require no constant current and can be activated by a pulse sent from a control panel.

Water Breaker is a device designed to work with all washing machines to detect leaks and automatically turn the water off.

In the event of a leak or when the drain starts to back up and overflow, the Water Breaker will not only turn the water off but will also turn the washing machine off.

This means that if a hose burst or the machine itself starts leaking, in seconds the water is off preventing damage to the floor. If the drain is stopped up instead of the washer spinning water onto the floor, this device will turn the machine off.

This device preventing the floor from getting flooded with water one time can save the homeowner hundreds and thousands of dollars in costly water damage repair.

1. It is the only leake detector control panal with both a DC current relay and an AC current relay. This enables the control panal to have a 120 vAC outlet for the machine to plug into, this giving once the control panal receives the signal from the sensor that water is on the floor the ability to turn the washing machene off. This feature is important because with out this, you would have no way to keep the washing machine from spinning water on the floor in the event the drain is stopped up and water is backing up into the floor.
This control panel is unique because it operates DC and AC curent at the same time, giving the ability to the water valves off with the DC power relay and the washing machine off, using the AC relay both at the same time. Also, the power to the washing machine and the water valves can be opened by hitting the reset button both at the same time.
It is the only leake detector that the control panal is designed to create both a positive and negative pulse to open and close magnetic and residual latching valves. that operates without constant current. This giving our leak detector the ability to turn the water off without the valves getting hot once the water flow has stopped like other solenoid valves that has constant current. Once the valve is closed and water flow has stopped they get hot after a period of time.
This leake detector control panal can be mounted on the wall behind the washing machine, or be mounted in the washing machine at the factory as part of the machine itself
Recap of Claimes:
The only leake detector with both AC and DC current that operates at the same time.
The only one that creates both a positive and negative pulse.
The only leake detector that the water valves are magnetic and residual latching valves that operates on a pulse not constant current.
The only one that can turn the mache and water valves off.
At the same time this preventing water from getting on the floor from both overflowing drains and busted hoses.
The only leake detector control panel that has a reset button, when pushed restores both AC and DC current.
